(19) United States
(12) Patent Application Publication
(10) Pub. No.: US 2026/0160123 A1
(43) Pub. Date: Jun. 11, 2026

(54) MODULAR STORM SHUTTER SYSTEM

(71) Applicant: Peter J. Luciani, JR., Buzzards Bay, MA (US)

(72) Inventor: Peter J. Luciani, JR., Buzzards Bay, MA (US)

(21) Appl. No.: 19/379,838

(22) Filed: Nov. 5, 2025

Related U.S. Application Data
(60) Provisional application No. 63/728,291, filed on Dec. 5, 2024.

(51) Int. Cl. E06B 9/04; E06B 9/00

(52) U.S. Cl. CPC E06B 9/04; E06B 2009/005

(57) ABSTRACT

A modular, storm shutter system includes reinforced sliding panels installed within upper and lower sliding tracks. Each panel comprises a vertically elongated face panel including a plurality of spaced vertical reinforcing ribs. The face panel is bordered by upper and lower and left and right frame elements for additional strength. The upper frame element includes a downward hanger blade portion with a plastic blade cap. The lower frame element includes a downwardly extending bottom hanger blade with a plastic blade cap. The upper track is an elongated body portion with an upwardly extending mounting flange, and a depending J-shaped hanger channel. The lower track is an elongated, W-shaped channel having a taller rear wall which functions as a mounting flange, while the middle, bottom and forward walls of the channel form an upwardly open hanger channel for receiving the blade cap of the lower frame element.

### CROSS-REFERENCE TO RELATED APPLICATIONS

This application claims the benefit of U.S. Provisional Patent Application No. 63/728,291, filed Dec. 5, 2024, the entire contents of which is incorporated herein by reference.

### BACKGROUND OF THE DISCLOSURE

### (1) Field of the Invention

The instant invention relates to storm shutter systems, and more particularly to a barn-door style sliding shutter system which is aesthetically attractive to permanently remain installed on a home's exterior yet is easily movable between open and closed positions during inclement weather event.

### (2) Description of Related Art

Glass windows as used in conventional home construction typically do not have sufficient strength to withstand the strong winds and flying debris often generated in a tropical storm or hurricane. Accordingly, a multitude of window shutter systems have been developed over the years in attempts to try to protect windows and doors during storms. Many of these existing shutter systems include temporary panels that may be nailed, screwed, or bolted to the home structure to cover the window or door. Shutters may also be actively deployed during periods of extended absence to protect against vandalism and theft and to avoid the need to visit the home to close the shutters when away.

Some of the existing systems are permanently attached to the structure, and then selectively moved into place over the window at the appropriate time. Roll-down window and door shields and folding awnings are examples. While effective, these solutions are typically unattractive with large housings and may often need be stored away during the non-hurricane season.

Other known systems employ tracks permanently installed with made-to-fit panels that slide in when the storm approaches. However, the panels are not normally left in place in the tracks and is instead stored in a garage or somewhere else most of the time. Other shutter systems employ multiple removable panels that can be inserted and then overlap from the top down. Some rather involved designs utilize a transparent storm shutter that can be rolled up or down but, are also hinged at the top so they can be propped open at the bottom to provide ventilation.

One significant drawback to all these prior designs is the lack of any regard for the aesthetic appearance of the panels, and in nearly all cases they are not part of the structure's decor. In addition, as noted above, many require a remote storage location. Hence, it would be desirable to have storm shutter system that is both attractive and functional and consequently eliminate the need to remove and store the shutters elsewhere and then re-install them when needed.

In many coastal hurricane prone areas of the country, storm shutters must meet building code requirements. In the aftermath of hurricane Andrew, which hit South Florida on Aug. 24, 1992, the building code requirements in South Florida were made significantly more stringent. The South Florida Building Code, one of the most stringent in the United States, now requires storm shutters to meet large and small missile impact tests. For example, for a large missile impact test, the shutter must withstand two impacts from a 2×4 inch wooden missile, weighing 9 pounds, fired from an air cannon at 50 feet per second (34 m.p.h.).

Many of the shutters currently available cannot withstand the described large missile impact test. Among the shutter's failures in the test, the slats collapse, separating at the interconnection points and from the perimeter frame allowing the missile to pass through the shutter. To meet the stringent building code requirements, shutter manufacturers are adding backing support material to strengthen existing shutter designs. This often requires modification or replacement of existing support frame members.

In view of the prevalence of such storms it is imperative that private homes and apartments as well as hotels and other commercial buildings have some type of storm shutters which can be easily handled and quickly deployed in a minimum of time. Such shutters should take little storage space and must be extremely strong to withstand high wind pressures. The shutter must offer positive protection for the windows against wind-carried debris and should aid, if possible, the water-tight features built into most jalousie or casement windows, or at least not detract from the effectiveness of such features.

It is also of note that the present systems that do remain in place on permanent tracks suffer from the fact that they may be left in an inactive position for long periods of time. This inactivity results in accumulation of dirt and debris in the tracks and attendant failure of wheel roller bearings that can prevent the shutters from being deployed when they are needed.

There is therefore an unmet need for a storm shutter system which is structurally strong and durable, yet also lightweight and aesthetically acceptable for permanent installation. Further, there is a need for a shutter system that can be permanently installed and remain in place in an attractive stowed position yet provide quick and reliable deployment when the need arises.

### SUMMARY OF THE DISCLOSURE

According to exemplary embodiments of the invention, a modular, sliding storm shutter system includes opposed pairs of reinforced sliding panels installed within upper and lower sliding tracks.

Each panel comprises a vertically elongated metal face panel including a plurality of vertical reinforcing ribs. The panel is bordered by upper and lower and left and right frame elements for additional reinforcement and strength.

The left and right frame elements each include a forward face portion and a rearwardly extending sidewall portion. The upper frame element is generally an inverted U-shape including a forward face portion, a rearward sidewall portion and a downward hanger blade portion. A Delrin™ plastic blade cap is received along at least a portion of the length of the hanger blade. The lower frame element may be planar and may further includes an inverted U-shaped hanger channel with the outer, or forward, wall secured with the frame element and the inner, or rearward wall forming a downwardly extending bottom hanger blade. A Delrin™ plastic blade cap is also received along at least a portion of the length of the bottom hanger blade.

The frame elements, panel and lower hanger channel may be welded together at select overlapping locations to form a unitary panel assembly.

The upper track comprises an elongated extruded body portion, an upwardly extending mounting flange, and a depending J-shaped hanger channel. The rear wall of the J-channel depends from the lower wall of the housing while the bottom and front wall thereof provide an upwardly open, forward facing, generally square hanger channel for receiving the Delrin blade cap of the upper frame element.

The lower track comprises an elongated, extruded roughly W-shaped channel having a taller rear wall which functions as a mounting flange, while the middle, bottom and forward walls of the forward portion of the channel form an upwardly open hanger channel for receiving the Delrin blade cap of the lower frame element.

For installation, the upper track is secured to the building structure above the window to be protected. Fastener openings are provided along the length for multiple fastening points to support the weight of the panels. The Delrin capped upper hanger blades of a pair of panels are slidably inserted into the hanger channels from the end(s) of the upper track channels. Once the panels are hanging from the upper track, the lower track channel can be upwardly fit onto the Delrin capped lower hanger blades of the panels and secured in place. Fastener openings are provided along the length for multiple fastening points. The fastening points are accessible along the length by sliding the panels left and right in the tracks to expose the fastening locations.

Alternatively, the upper and lower tracks can be hung first and the panels then inserted from the sides.

Generally, the upper and lower tracks will be slightly wider than double the width of the window to provides space to slide the panels to the opposed sides of the window in a normally open position. This will leave the window unobstructed during normal use. The vertically ribbed panel structure of the metal shutters provides a familiar window “shutter” look and feel with superior strength and durability which can also be painted or powder coated to match existing building décor as desired.

Wider windows, or mulled window sets, may be provided with two opposing pairs of interlocking panels which slide within a double set of channels provided on the upper and lower tracks. An inward (closest to the structure) pair of panels slides on an inward set of tracks, while an outward pair of panels slides on an outward set of tracks. The inward and outward panel on each side of the window overlap when deployed to the outer normally open position so that they appear as a single “shutter” panel. The outward panels are the same as in the single windows. However, the inner side edges of the inward panels will include a forwardly turned return wall or sidewall to interlock with the outward panel. Using the left side panels as an example, the right edge of the inward panel has a forwardly turned return wall while the left edge of the outward panel includes the normal inward return wall. The outward and inward sidewalls overlap when installed together and allow the inward and outward walls to interlock and move the panels together during leftward closing movement of the outward panel.

A drop-in hanging panel version includes a downwardly angled hanger channel as part of the upper frame element which is received over a mating upwardly angled support channel which replaces the previously described upper tracks. The bottom frame element includes a hanger blade which is received against an outside face of the lower track when installed. Retaining pins pass through the bottom hanger blade and lower track walls to secure the panel once positioned in place.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWINGS

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective view of an exemplary embodiment of a modular sliding storm shutter system (2 panel) in accordance with the teachings of the present disclosure;

FIG. 2 is a front view thereof with the panels in a closed position;

FIG. 3 is another front view thereof with the panels in an open position;

FIG. 4 is a cross-sectional view thereof taken along line 4-4 of FIG. 3;

FIG. 5 is an enlarged end view of upper track;

FIG. 6 is an enlarged end view of the lower track;

FIG. 7 is an enlarged end view of the upper track with an end cap installed;

FIG. 8 is a front perspective view of a shutter panel;

FIG. 9 is a rear perspective view thereof;

FIG. 10 is an exploded perspective view thereof;

FIG. 11 is a perspective view of another exemplary embodiment of a modular sliding storm shutter system (4 panel) in accordance with the teachings of the present disclosure;

FIG. 12 is a front view thereof with the panels in a closed position;

FIG. 13 is another front view thereof with the panels is an open position;

FIG. 14 is an enlarged end view of the upper track;

FIG. 15 is a cross-sectional view of the lower track taken along line 15-15 of FIG. 12;

FIG. 16 is a cross-sectional view of the upper track taken along line 16-16 of FIG. 12;

FIG. 17 is an enlarged end view of upper track;

FIG. 18 is an enlarged end view of the lower track;

FIG. 19 is a perspective view of one of the inner panels with forward turned sidewall;

FIG. 20 is a cross-sectional view of the shutter system taken along line 20-20 of FIG. 12;

FIG. 21 is an enlarged rear perspective of the upper corner of the inner and outer panels showing the overlap of the sidewalls;

FIG. 22 is a front view of another exemplary embodiment of a modular sliding storm shutter system (single panel drop-in) in accordance with the teachings of the present disclosure; and

FIG. 23 is a cross-sectional view thereof taken along line 23-23 of FIG. 22.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

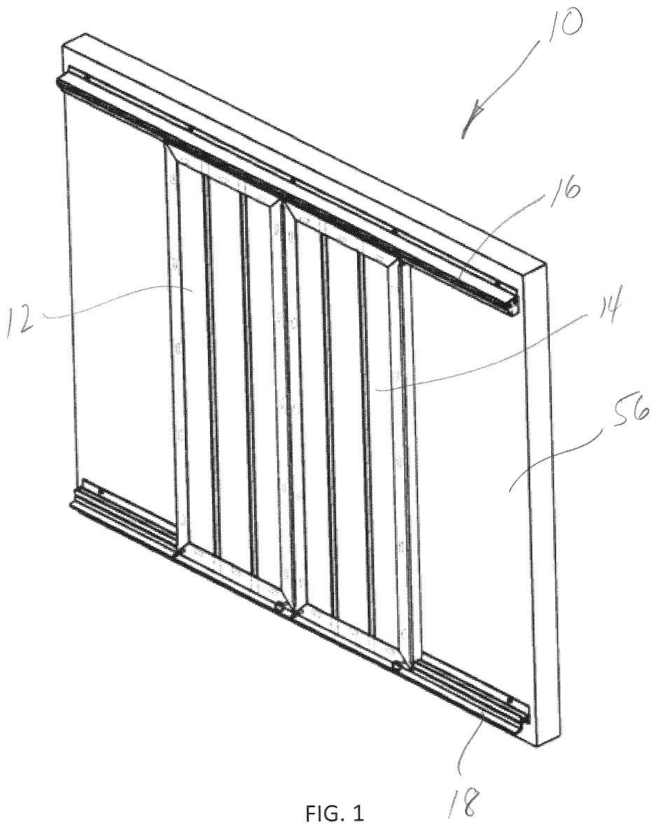

According to a first exemplary embodiment of the invention, and referring to FIGS. 1-10, a modular, sliding storm shutter system 10 includes opposed pairs of reinforced sliding panels 12, 14 installed within upper and lower sliding tracks 16, 18.

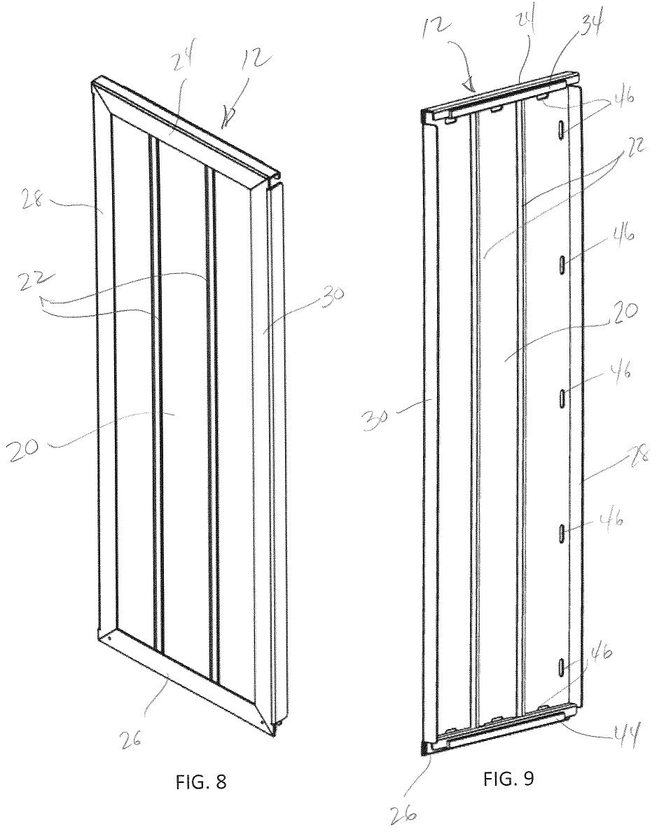

Referring to FIGS. 8-10, each panel 12,14 comprises a vertically elongated metal face panel 20 including a plurality of spaced vertical reinforcing ribs 22. Aluminum may be considered as a preferred choice of metal for weight and weather consideration, but other metals may also be suitable. Carbon fiber and reinforced plastics may also be suitable depending on varying environmental, cost and weight factors. Varying widths of the face panel may be used for different width requirements. The face panel 20 is bordered by upper and lower frame elements 24, 26 and left and right frame elements 28, 30 for additional reinforcement and strength.

The left and right frame elements 28, 30 each include a forward face portion which overlaps the front of the face panel and a rearwardly extending sidewall portion.

The upper frame element 24 is generally an inverted U-shape including a forward face portion that overlaps the face panel, a rearward sidewall portion and a downward hanger blade portion 32. A Delrin™ plastic blade cap 34 is received along at least a portion of the length of the hanger blade portion 32.

Delrin is identified as a preferred material for its mechanical, chemical, UV and weather resistant properties along with its low coefficient of friction, giving it a “slippery” surface. Among the beneficial characteristics of the blade cap material are the following:
Dimensional stability: Delrin retains its shape and size even when exposed to temperature changes and humidity.
Machinability: Delrin is easy to work with using conventional or advanced machinery. It also has better flow rates than other resins.
Impact and creep resistance: Delrin has superior impact and creep resistance.
Fatigue endurance: Delrin has high fatigue endurance.
Tensile strength: Delrin has high tensile strength.
Stiffness: Delrin has high stiffness.
Low moisture absorption: Delrin can operate in wet environments with little effect on performance or dimensions.
Chemical resistance: Delrin is chemically resistant to fuels, solvents, and neutral chemicals.
Wear and abrasion properties: Delrin has good wear and abrasion properties due to its low coefficient of friction and hard and resilient surface.
Density: Delrin's density makes it a good substitute for metals.

The lower frame element 26 may comprise a planar border panel 36 overlapping the face panel 20, an L-shaped welding flange 38 and may further include a second L-shaped hanger flange 40. The rearward wall of flange 40 forms a downwardly extending bottom hanger blade 42. A Delrin™ plastic blade cap 44 is also received along at least a portion of the length of the bottom hanger blade 38.

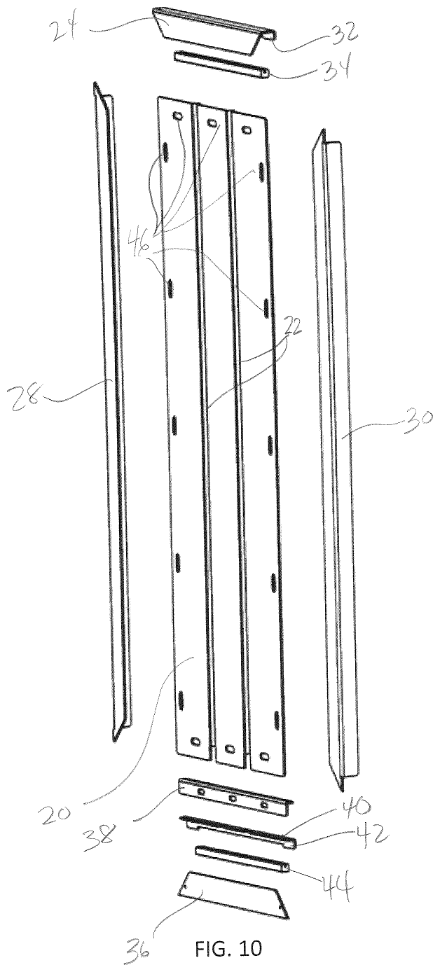

The face panel 20 and frame elements 24, 26, 28, 30, 36, 38, 40, may be welded together at select overlapping locations 46 (See FIGS. 9 and 10).

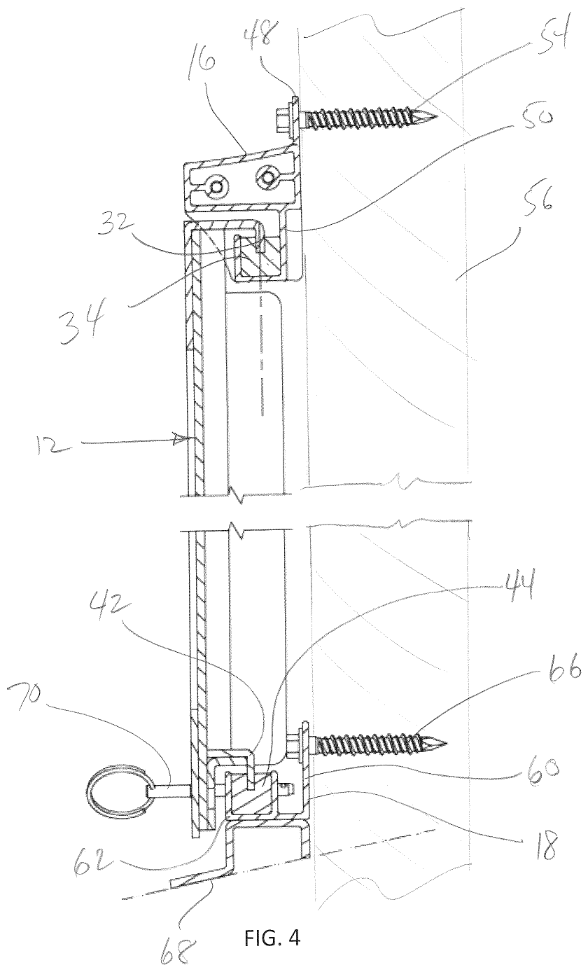

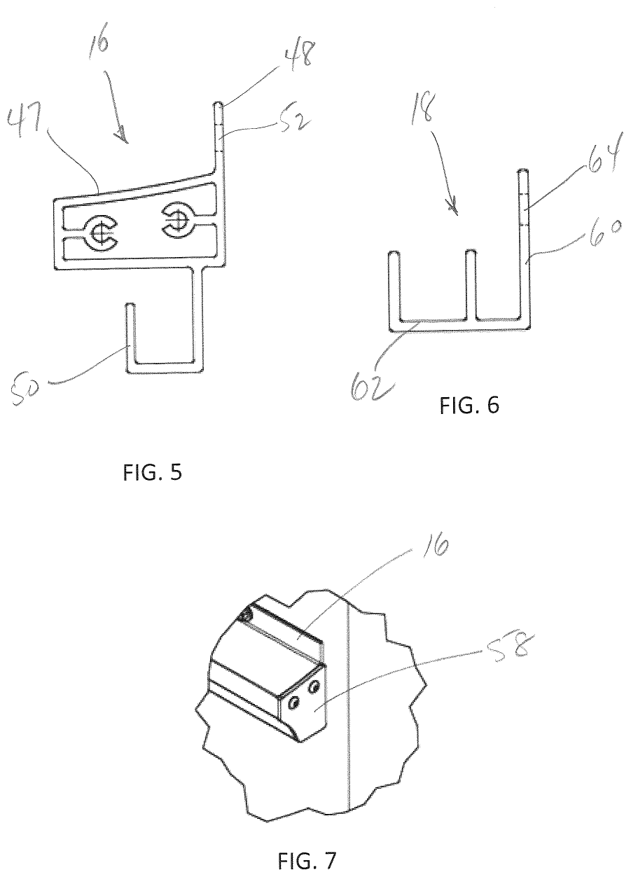

Referring to FIGS. 4 and 5, the upper track 16 comprises an elongated extruded body 47 having an upwardly extending mounting flange 48, and a depending J-shaped hanger channel 50. The mounting flange 48 may include a plurality of horizontally spaced fastener openings 52 to receive fasteners 54 for securing the upper track to a building structure 56. The rear wall of the J-channel 50 depends from the lower wall of the housing while the bottom and front wall thereof provide an upwardly open, forward facing generally square hanger channel for receiving the Delrin blade cap 34 of the upper frame element 24.

In some embodiments, the upper track 16 may include end plates 58 (see FIG. 7) to close off the channels and retain the panels 12, 14 within the track 16.

Referring to FIGS. 4 and 6, the lower track 18 comprises an elongated, extruded roughly W-shaped channel having a taller rear wall 60 which functions as a mounting flange, while the middle, bottom and forward walls of the forward portion of the channel form an upwardly open hanger channel 62 for receiving the Delrin blade cap 44 of the lower frame element 26. The mounting flange 60 of the lower track may also include a plurality of horizontally spaced fastener openings 64 to receive fasteners 66 for securing the lower track 18 to the building structure 56.

Some embodiments may include a lower sill cap 68 secured to the bottom of the lower track 18 to guide water away from the building structure (See FIG. 4).

For installation, the upper track 16 may be secured to the building structure 56 above the window to be protected. The Delrin capped upper hanger blades of the panels are slidably inserted into the hanger channels 50 from the end(s) of the upper track channels where the upper return wall of the upper frame element of each panel slides through the hanger gap forming an interlocking sliding hanger system. Once the panels 12, 14 are hanging from the upper track 16, the lower track channel 18 can be fit onto the Delrin capped lower hanger blades of the panels. The fastening points 64 are accessible along the length of the lower track 18 by sliding the panels left and right in the tracks to expose the fastening locations.

Alternatively, the upper and lower tracks can be hung first and the panels then inserted from the sides.

The panels 12, 14 may be selectively secured in place with pins 70 (See FIG. 4) which pass through aligned holes in the lower hanger blade 42 and lower track walls.

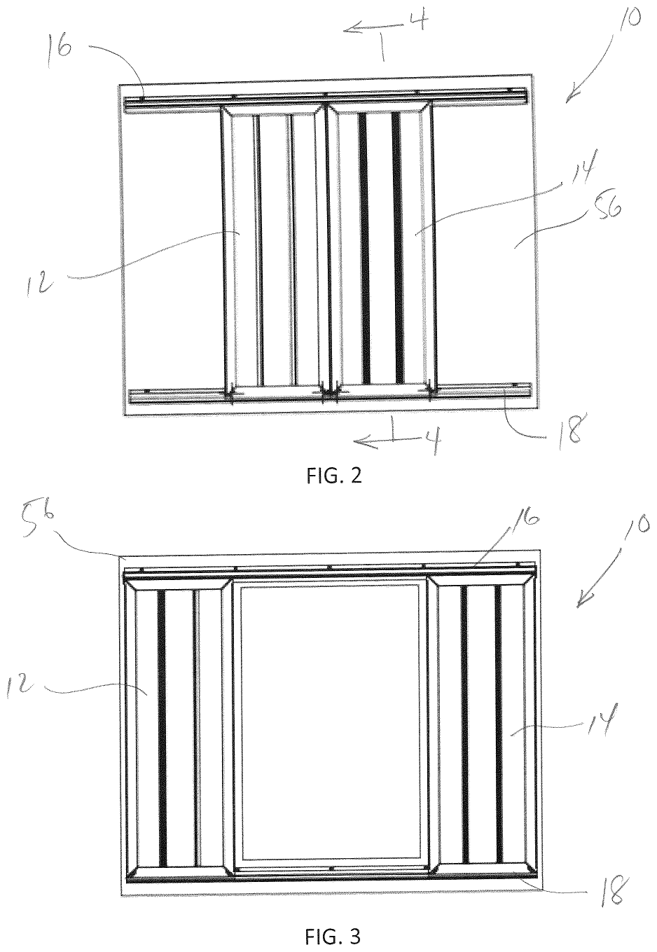

Generally, the upper and lower tracks 16, 18 will be slightly wider than double the width of the window to provides space to slide the panels 12. 14 to the opposed sides of the window in a normally open position. (See FIGS. 2-3) This will leave the window unobstructed during normal use. The ribbed panel structure of the metal shutters provides a familiar window “shutter” look and feel with superior strength and durability which can also be painted or powder coated to match existing building décor as desired.

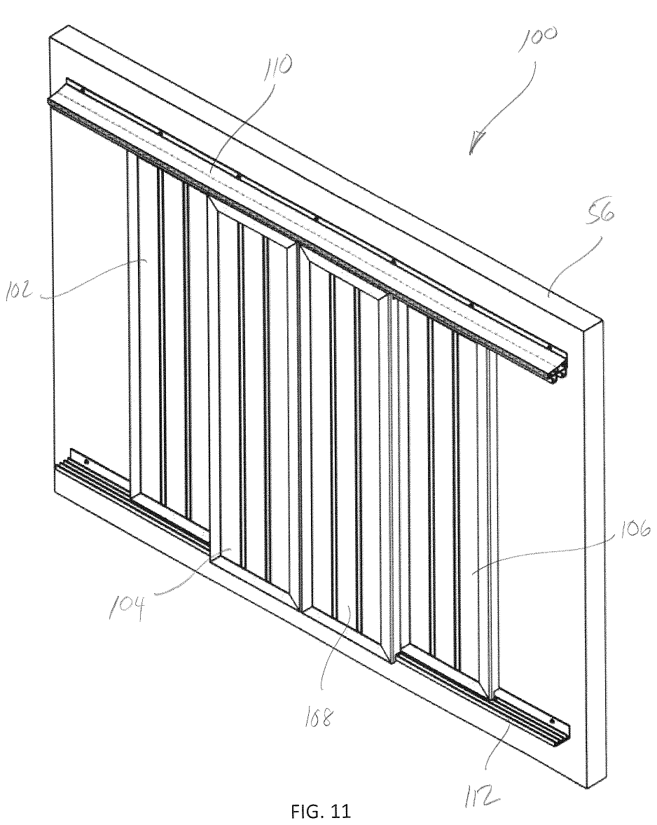

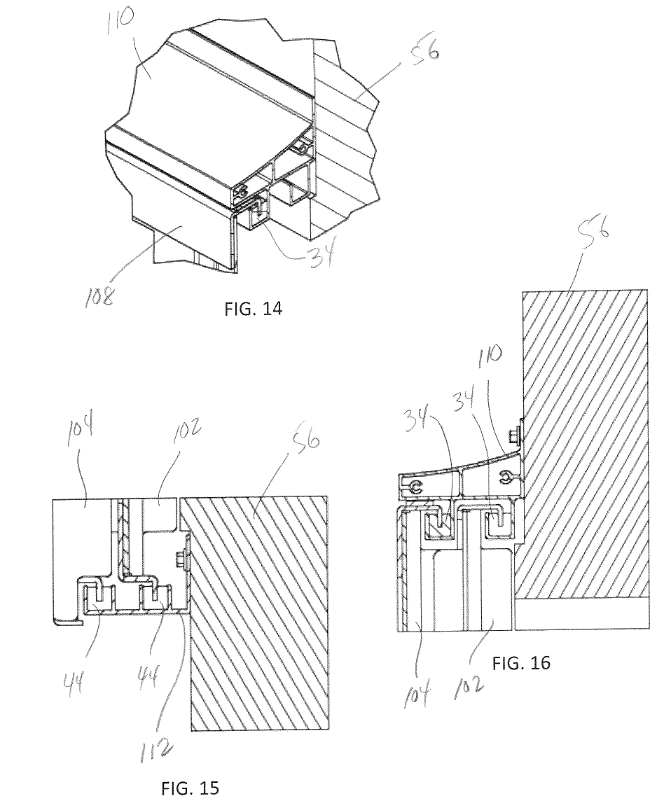

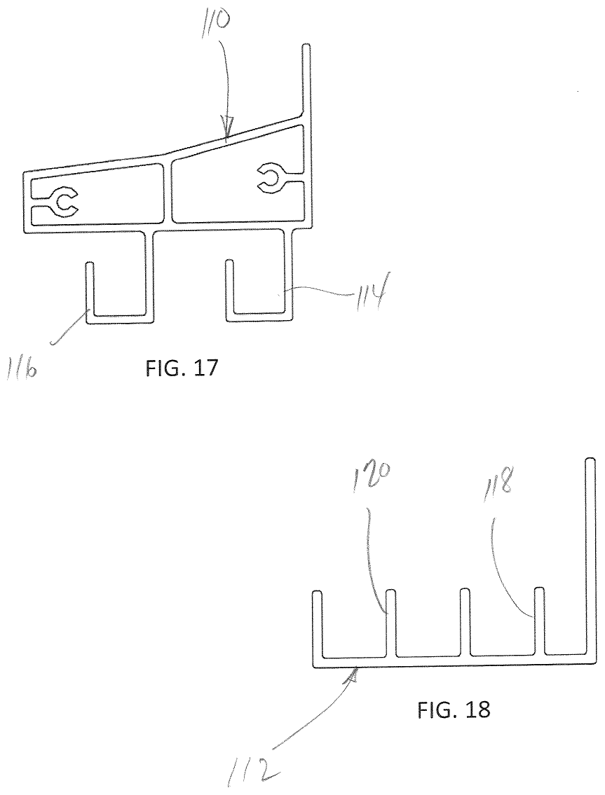

Referring now to FIGS. 11-21, wider windows, or mulled window sets, may be provided with a shutter system 100 comprising two pairs of interlocking panels 102, 104 and 106, 108 which slide within a double set of channels provided on upper and lower tracks 110, 112. Upper track 110 includes two parallel J-channels 114, 116, while lower track 112 including two parallel U-channels 118, 120

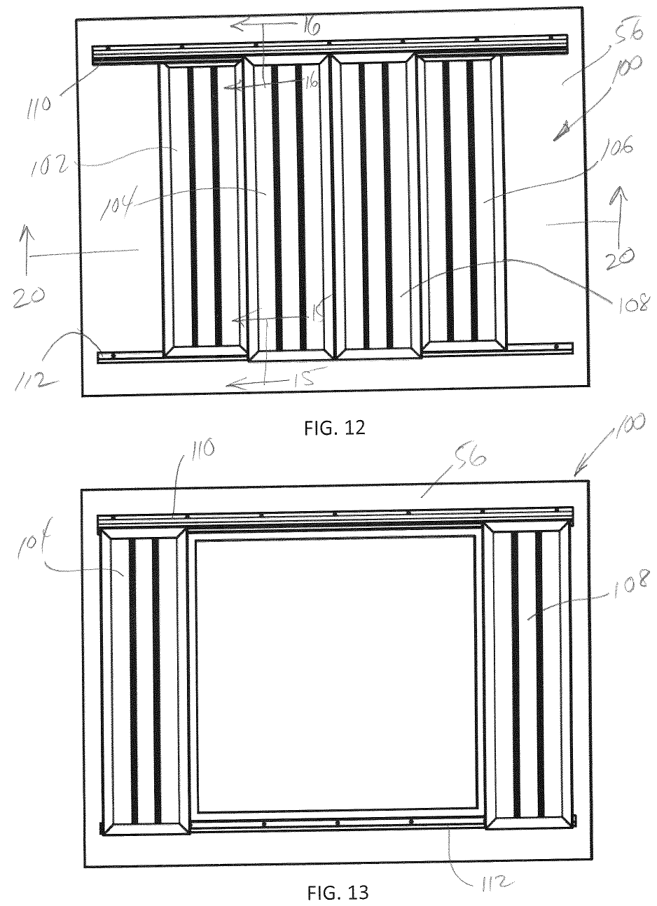

An inward (closest to the structure) pair of panels 102, 106 slides on an inward set of tracks, while an outward pair of panels 104, 108 slides on an outward set of tracks. The inward and outward panel (for example 102, 104) on each side of the window overlap when deployed to the outer normally open position so that they appear as a single “shutter” panel (See FIG. 13).

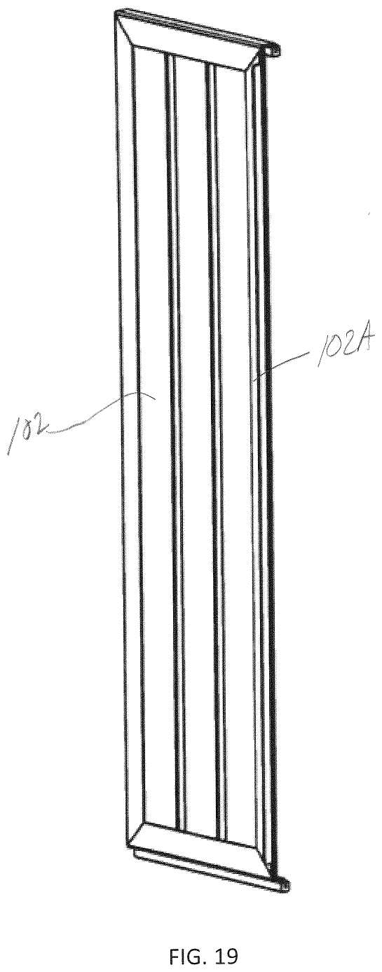

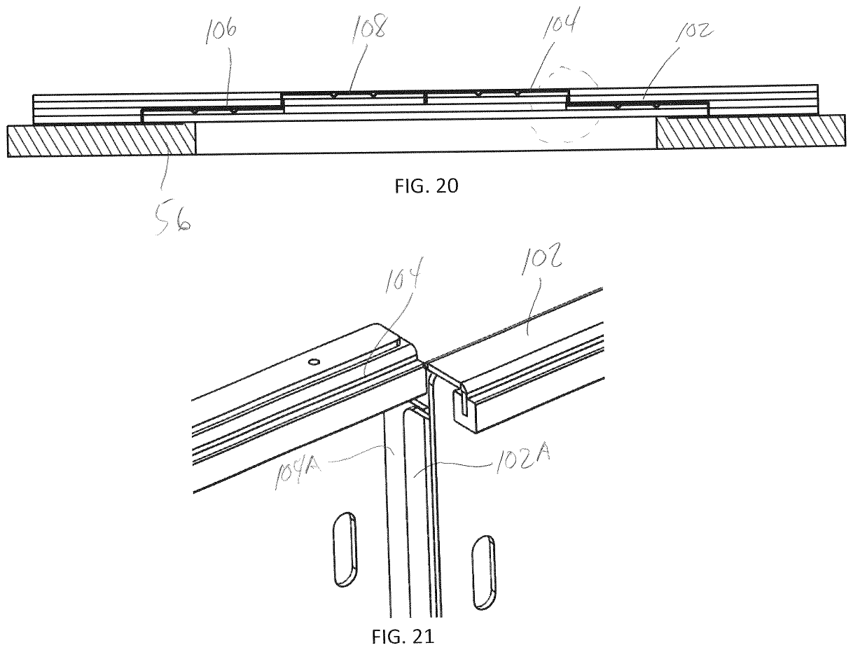

The outward panels 104, 108 are the same in all aspects as the panels 12, 14 described in the single window configuration 10 above. The inward panels 102, 106 are also the same in nearly all aspects as described in the single window configuration above with the exception that the inner side edges of the inward panels 102. 106 will include a forwardly turned return wall to interlock with the rearward sidewall of the outward panels 104, 108 (See FIGS. 19-21). Using the left side panels 102, 104 as an example, the right edge of the inward panel has a forwardly turned return wall 102A while the right edge of the outward panel 104 includes the normal inward return wall 104A. The outward and inward sidewalls 102A, 104A overlap when installed together and allow the inward and outward walls 102, 104 to interlock and move the panels together during rightward closing movement of the outward panel 104 (See callout circle in FIG. 20 enlarged in FIG. 21).

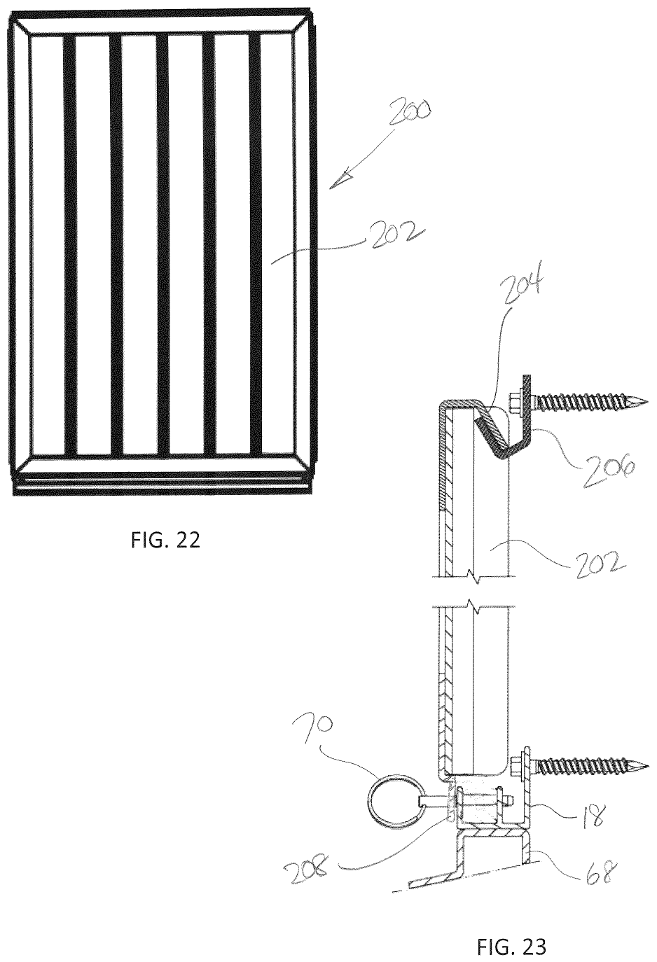

Referring now to FIGS. 22 and 23, a drop-in hanging panel system 200 includes one or more panel(s) 202 which are nearly identical to the above panels 10, 12 with the exception that the panel(s) 202 includes a downwardly angled hanger lip 204 as part of the upper frame element. The hanger lip 204 is received over a mating upwardly angled support track 206 which replaces the previously described upper tracks 16, 110. (See FIG. 23).

The bottom frame element includes a similar hanger blade 208 which differs only in that it is formed with the bottom frame element and located slightly more forward on the panel 202. When the panel is hung in place, the hanger blade 208 is received against an outside face of the lower track 18 when installed. Retaining pins 70 pass through the bottom hanger blade 208 and walls of the lower track 18 to secure the panel 202 once positioned in place.

All the aluminum components as described herein may be painted or powder coated for both aesthetic desirability and weather resistance. The Delrin blade caps 34, 44 slide easily within the power coated tracks 16, 18 or 110, 112.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A modular storm shutter system comprising:
an opposed pair of sliding panels, each panel comprising a metal face panel bordered by upper and lower and left and right frame elements,
each of said left and right frame elements including a forward face portion and a rearwardly extending sidewall portion,
the upper frame element comprising an inverted U-shape including a forward face portion, a rearward sidewall portion, a downward hanger blade portion and a plastic blade cap received along at least a portion of the length of the hanger blade portion,
the lower frame element comprising a planar face portion, a downwardly extending bottom hanger blade and plastic blade cap received along at least a portion of the length of the bottom hanger blade,
an upper track comprising an elongated body portion, an upwardly extending mounting flange, and a depending J-shaped hanger channel wherein a rear wall of the J-channel depends from the lower wall of the housing and a bottom and a front wall thereof provide an upwardly open, forward facing generally square hanger channel for receiving the blade cap of the upper frame element; and
a lower track comprising an elongated roughly W-shaped channel having a taller rear mounting wall, wherein a middle, a bottom and a forward wall of the forward portion of the W-shaped channel form an upwardly open hanger channel for receiving the plastic blade cap of the lower frame element.

2. The modular storm shutter system of claim 1 wherein the metal face panel includes at least one vertical reinforcing rib.

3. The modular storm shutter system of claim 1 wherein the plastic blade caps comprise Delrin.

4. The modular storm shutter system of claim 1 further comprising at least one securing pin which passes through a set of aligned holes in the lower hanger blade and walls of the lower track.

5. The modular storm shutter system of claim 1 wherein the panels, frame elements and lower hanger channel are welded together.

6. A modular storm shutter system comprising:
an opposed pair of sliding panels, each panel comprising a metal face panel bordered by a plurality of frame elements including an upper frame element comprising an inverted U-shape having a downward hanger blade portion and a plastic blade cap received along at least a portion of the length of the hanger blade portion, and a lower frame element comprising a downwardly extending bottom hanger blade and plastic blade cap received along at least a portion of the length of the bottom hanger blade,
an upper track comprising an elongated body portion and a depending J-shaped hanger channel wherein the J-channel forms a forward facing generally square hanger channel for receiving the blade caps of the upper frame elements; and
a lower track comprising an elongated roughly W-shaped channel for receiving the plastic blade caps of the lower frame elements.

7. The modular storm shutter system of claim 6 wherein the metal face panel includes at least one vertical reinforcing rib.

8. The modular storm shutter system of claim 6 wherein the plastic blade caps comprise Delrin.

9. The modular storm shutter system of claim 6 further comprising at least one securing pin which passes through a set of aligned holes in the lower hanger blade and walls of the lower track.

10. The modular storm shutter system of claim 6 wherein the panels, frame elements and lower hanger channel are welded together.

11. A storm shutter panel comprising:
a face panel bordered by upper and lower and left and right frame elements,
each of said left and right frame elements including a forward face portion and a rearwardly extending sidewall portion,
the upper frame element comprising an inverted U-shape including a forward face portion, a rearward sidewall portion, a downward hanger blade portion and a plastic blade cap received along at least a portion of the length of the hanger blade portion,
the lower frame element comprising a planar face portion, a downwardly extending bottom hanger blade and plastic blade cap received along at least a portion of the length of the bottom hanger blade.

12. The storm shutter panel of claim 4 wherein the face panel, frame elements and lower hanger channel are welded together.
